(19) United States
(12) Patent Application Publication
(10) Pub. No.: US 2009/0235553 A1
(43) Pub. Date: Sep. 24, 2009

(54) Laundry Dryer

(76) Inventors: Sang Hun Bae, Gyeongsangnam-do (KR); Chul Jin Choi, Gyeongsangnam-do (KR); Dong Hyun Kim, Gyeongsangnam-do (KR); Young Bok Son, Gyeongsangnam-do (KR)

Correspondence Address: MCKENNA LONG & ALDRIDGE LLP, 1900 K STREET, NW, WASHINGTON, DC, 20006, US

(21) Appl. No.: 12/309,323

(22) PCT Filed: Sep. 27, 2007
(86) PCT No.: PCT/KR2007/004700

§ 371 Date: Jan. 14, 2009

(30) Foreign Application Priority Data
Sep. 29, 2006 (KR) 1020060095258

(51) Int. Cl. F26B 21/00; D06F 58/04; F26B 19/00; G05B 15/00

(52) U.S. Cl. 34/524; 34/130; 34/89; 700/275

(57) ABSTRACT

The present invention relates to a laundry dryer capable of removing and/or preventing wrinkles of laundry. A laundry dryer includes a drum to hole laundry, a steam generator to selectively supply steam to the drum, a water supply source to hold water that is supplied to the steam generator, a water softening member provided in the water supply source to soften water, and a drain hose through which the water of the water supply source is selectively drained outside.

### TECHNICAL FIELD

The present invention relates to a laundry dryer. More specifically, the present invention relates to a laundry dryer capable of removing and/or preventing wrinkles of laundry.

### BACKGROUND ART

Laundry dryers are typically electric appliances that dry washed laundry, mainly washed clothes, by using high temperature air. In general, a laundry dryer is configured of a drum, a driving source, heating means and a blower unit. Laundry is held in the drum and the driving source drives the drum. The heating means heats air drawn in the drum. The blower unit sucks or discharges the air inside the drum.

Laundry dryers may be categorized, based on a method of heating air that is heating means, into electric-type laundry dryers and gas-type laundry dryers. In an electric-type laundry dryer, air is heated by using electric resistance heat. While, in a gas-type laundry dryer, air is heated by using heat generated from gas combustion. On the other hand, laundry dryers may be categorized into condensation-type laundry dryers and exhaustion-type laundry dryers. In a condensation-type laundry dryer, air is heat-exchanged with laundry in the drum and the damp air is circulated, not discharged outside, to be heat-exchanged with external air at an auxiliary condenser. At this time, water is condensed and discharged outside. In an exhaustion-type laundry dryer, air is heat-exchanged with laundry in the drum and the damp air is directly discharged outside the laundry dryer. Also, laundry dryers may be categorized, based on a method of loading laundry, into top loading-type laundry dryers and front loading-type laundry dryers. In a top loading-type laundry dryer, laundry is loaded into the drum through a top of the laundry dryer. In a front loading-type laundry dryer, laundry is loaded into the drum through a front of the laundry dryer.

### DISCLOSURE OF INVENTION

### Technical Problem

However, above conventional laundry dryers may have following problems.

Commonly, the laundry having performed washing and spinning is loaded and dried in the conventional laundry dryers. In a view of a principle of water washing, washed laundry has wrinkles and the wrinkles created during the washing and spinning are not removed during the drying. As a result, auxiliary ironing is necessary in the conventional laundry dryer to remove the wrinkles, which causes a problem.

Moreover, in case that clothes rather than the washed laundry are kept and used, the clothes like the washed laundry may have wrinkles, crumples and fold marks (hereinafter, referenced to as wrinkles ). Accordingly, there have been demands for development of devices capable of removing wrinkles easily even after common usage and keeping.

### Technical Solution

To solve the problems, an object of the present invention is to provide a laundry dryer that can prevent and/or remove wrinkles of laundry.

Another object of the present invention is to provide a laundry dryer and a control method thereof, which can drain salt water remaining after regenerating a water softening member conveniently.

To achieve these objects and other advantages and in accordance with the purpose of the invention, as embodied and broadly described herein, a laundry dryer includes a drum to hole laundry; a steam generator to selectively supply steam to the drum; a water supply source to hold water that is supplied to the steam generator; a water softening member provided in the water supply source to soften water, and a drain hose through which the water of the water supply source is selectively drained outside.

Here, the water softening member may include an ion exchange resin. Specifically, the water softening member may include a lower housing provided in the water supply source, the lower housing having a plurality of through-holes; an upper housing detachable from the lower housing, the upper housing having a plurality of through-holes, wherein the ion exchange resin is filled up in a predetermined space formed by the upper and lower housing.

The laundry dryer may further include a lime sensor to sense an amount of lime dissolved in the water of the water supply source; a warning part to warn a user more than a predetermined amount of lime if more than a predetermined amount of lime is sensed by the lime sensor; and a controller to control the lime sensor and the warning part.

It is preferable that the laundry dryer further includes a regeneration operation instructing part to transmit a signal to the controller if the ion exchange resin starts to be regenerated.

Here, it is preferable that the controller controls the water inside the water supply source to be drained through the drain hose, not to be supplied to the steam generator, if controller receives the signal from the regeneration operation instructing part.

The drain hose may be directly connected to the water supply source. It is preferable that the laundry dryer further includes a valve to selectively open and close a path to the drain hose. As a result, the controller controls the valve to be opened if the controller receives the signal from the regeneration operation instructing part.

The laundry dryer may further include a pump to supply the water held in the water supply source to the steam generator. In this case, the drain hose is provided between the steam generator and the pump. The drain hose may include a first valve provided between the steam generator and the pump and a second valve provided at the drain hose. As a result, the controller controls to close the first valve and to open the second valve if the controller receives the signal from the regeneration operation instructing part.

On the other aspect of the present invention, a control method of a laundry dryer having a steam generator to supply steam to a drum holding laundry, a water supply source to hold water to supply water to the steam generator and a water softening member, having an ion exchange resin, provided in the water supply source to soften the water, the method includes a sensing step to sense an amount of lime dissolved in the water of the water supply source; a warning step to warn a user more than a predetermined amount of lime, if more than predetermined amount of lime is sensed; a regenerating step to regenerate the ion exchange resin: and a draining step to drain the water of the water supply source outside if the ion exchange resin is regenerated.

### ADVANTAGEOUS EFFECTS

The present invention has an advantageous effect of preventing and/or removing wrinkles of laundry efficiently.

### BRIEF DESCRIPTION OF THE DRAWINGS

The accompanying drawings, which are included to provide further understanding of the disclosure and are incorporated in and constitute a part of this application, illustrate embodiments of the disclosure and together with the description serve to explain the principle of the disclosure.

In the drawings:

FIG. 1 is an exploded perspective view illustrating an embodiment of a laundry dryer according to the present invention;

FIG. 2 is a longitudinally sectional view of FIG. 1;

FIG. 3 is a sectional view illustrating a steam generator shown in FIG. 1;

FIG. 4 is a perspective view schematically illustrating another embodiment of a laundry dryer according to the present invention;

FIG. 5 is an exploded perspective view illustrating an example of a water supply source shown in FIG. 4;

FIG. 6 is an exploded perspective view illustrating a water softening member shown in FIG. 5;

FIG. 7 is a diagram illustrating another embodiment of a laundry dryer according to the present invention; and

FIG. 8 is a block view schematically illustrating a control system of the laundry dryer according the embodiments of the present invention.

### BEST MODE FOR CARRYING OUT THE INVENTION

Reference will now be made in detail to the specific embodiments of the present invention, examples of which are illustrated in the accompanying drawings. Wherever possible, the same reference numbers will be used throughout the drawings to refer to the same or like parts.

To explain a laundry dryer according to the present invention, a top loading-type, electric-type and exhaustion-type laundry dryer will be presented as examples on convenience sake. However, the present invention is not limited to the above examples and it can be applicable to a front loading-type, gas-type and condensation-type laundry dryer.

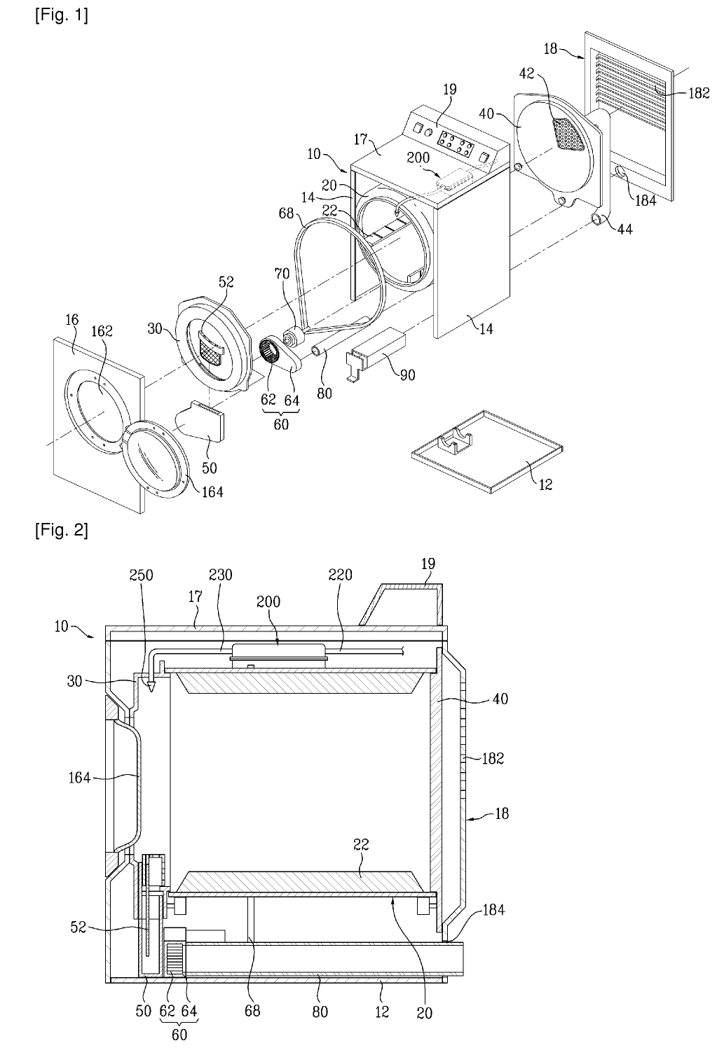

In reference to FIGS. 1 and 2, an embodiment of the laundry dryer according to the present invention will be explained.

A cabinet 10 defines an exterior appearance of the laundry dryer and a drum 20 is rotatable in the cabinet 10. A motor 70 and a belt 68 drive the drum 20. A hot air heater 90 is provided in a predetermined portion of the cabinet 10 to heat air and to create high temperature air (hereinafter, hot air). A hot air supply duct 44 is provided in a predetermined portion of the cabinet 10 to supply the hot air of the hot air heater 90 to the drum 20. Also, there are provided an exhaustion duct 80, a blower unit 60 in the laundry dryer according to the present invention. The damp air heat-exchanged with the laundry in the drum 20 is discharged outside the drum 20 through the exhaustion duct 80 and the blower unit 60 sucks the damp air. A steam generator 200 is provided in a predetermined portion of the cabinet 10 to generate high temperature steam. This embodiment presents on convenience sake an indirect drive type in that the drum 20 is rotated by the motor 700 and the belt 68 and the present invention is not limited thereto. That is, it is possible to apply to the present invention a direct drive type in that the drum 20 is directly rotated by connecting the motor 70 to a rear surface of the drum 20.

Each configuration will be explained in detail.

The cabinet 10 defines an exterior appearance of the laundry dryer and it includes a base 12, a pair of side covers 14, a front cover 16, a rear cover 18 and a top cover 17. The base 12 forms a bottom surface of the laundry dryer and the side covers 14 are perpendicular to the base 12. The front cover 16 and the rear cover 18 are installed in a front portion and a rear portion of the side covers 14, respectively. The tope cover 17 is installed in an upper portion of the side covers 14. A control panel 19 having various operational switches is positioned at the top cover 17 or the front cover 16 and the door 164 is coupled to the front cover 16. An air inlet 182 and an air outlet 184 are provided at the rear cover 18. External air is drawn through the air inlet 182 and the air inside the drum 20 is discharged outside through the air outlet 184 that is a final path to an outside.

An inner space of the drum 20 is employed as a drying chamber for drying the laundry. It is preferable that a lifter 22 is installed in the drum 20 to lift and drop the laundry, such that the laundry is turned over to enhance drying efficiency.

On the other hand, a front supporter 30 is provided between the drum 20 and the cabinet 10, in other words, between the drum 20 and the front cover 16. A rear supporter 40 is provided between the drum 20 and the rear cover 18. The drum 20 is rotatable between the front supporter 30 and the rear supporter 40, and sealing members (not shown) for preventing water leakage are coupled between the front supporter 30 and the drum 20 and between the drum 20 and the rear supporter 40, respectively. The front supporter 30 and the rear supporter 40 of the drum 20 close a front and a rear surface, respectively, to support a front and rear end of the drum 20 as well as to form the drying chamber.

An opening is formed at the front supporter 30 to communicate the drum 20 with an outside and the opening is selectively opened and closed by the door 164. In addition, a lint duct 50 as a path through which the air in the drum 20 flows outside is connected to the front supporter 30 and a lint filter 52 is installed at the lint duct 50. A predetermined portion of the blower unit 60 is connected to the lint duct 50 and the other opposite predetermined portion of the blower unit 60 is connected to the exhaustion duct 80. Here, the exhaustion duct 80 is in communication with the air outlet 184 provided at the rear cover 18. As a result, once the blower unit 60 is operated, the air inside the drum 20 flows through the lint duct 50, the exhaustion duct 80 and the air outlet 184 in order, only to be exhausted outside. At this time, foreign substances including lint are filtered by the lint filter 52. Commonly, the blower unit 60 is configured of a blower 62 and a blower housing 64. The blower 64 is commonly connected to the motor 70 for driving the drum 20.

An opening 42 formed of plural through-holes is formed at the rear supporter 40 and the hot air supply duct 44 is connected to the opening 42. The hot air supply duct 44 is in communication with the drum 20 and it is employed as a path for supplying hot air to the drum 20. For that, the hot air heater 90 is mounted in a predetermined portion of the hot air supply duct 44.

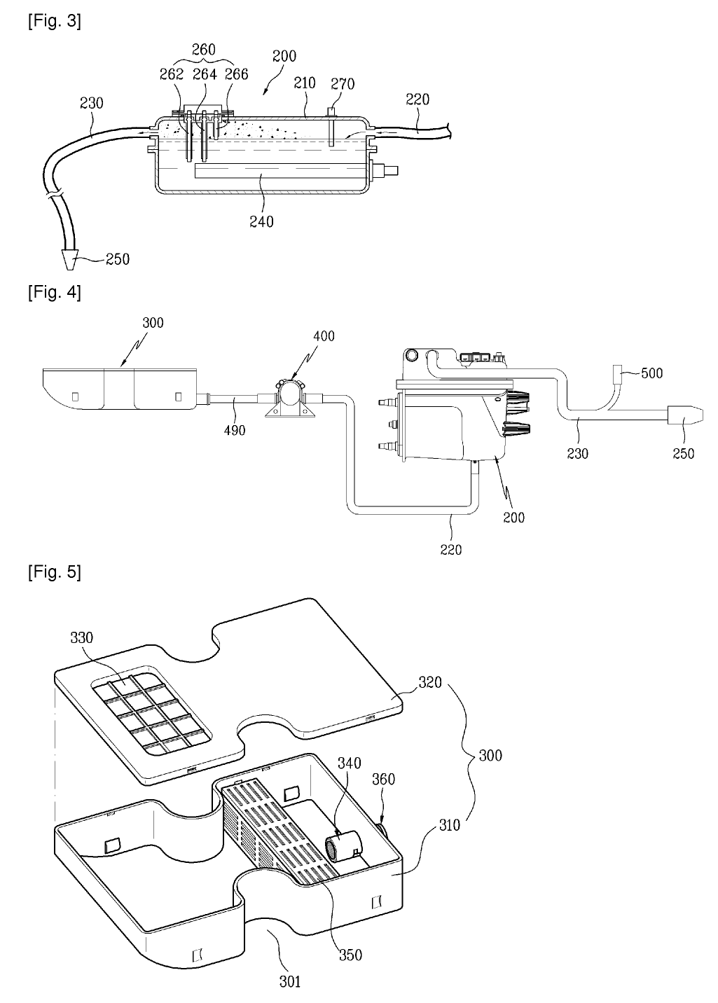

On the other hand, the steam generator 200 is provided in a predetermined portion of the cabinet 10 to generate steam and the generated steam is supplied to the drum 20. In reference to FIG. 3, the steam generator 200 will be explained in detail.

The steam generator 200 is configured of a tank 210, a heater 240, a water level sensor 260 and a temperature sensor 270. Water is held in the tank 210 and the heater 240 is mounted in the tank 210. The water level sensor 260 senses water levels in the steam generator 200 and the temperature sensor 270 senses temperatures in the steam generator 200. The water level sensor 260 is configured of a common electrode 262, a low water level electrode 264 and a high water level electrode 266. A high water level is sensed based on whether an electric current is applied between the common electrode 262 and the high water level electrode 266, and a low water level is sensed based on whether an electrode current is applied between the common electrode 262 and the low water level electrode 264.

A water supply hose 220 is connected to a predetermined portion of the steam generator 200 and a steam hose 230 is connected to the other opposite predetermined portion of the steam generator 200. Here, it is preferable that a nozzle 250 having a predetermined shape is provided at a front end of the steam hose 230. An end of the water supply hose 220 is typically connected to an external water supply source such as a water tap. The nozzle 250, that is, a steam outlet is positioned at a predetermined portion in the drum 20 to spray steam in the drum 20.

In the meantime, this embodiment presents a kind of the steam generator 200 in that the heater 240 heats the water in the tank 210 to generate steam (called as tank heating type steam generator on convenience sake) and the present invention is not limited thereto. That is, any devices capable of generating steam may be applicable to the present invention. For example, a kind of a steam generator in that a heater is directly installed around a water supply hose to heat the water in the water supply hose, without storing water in a predetermined space, (called as a pipe heating type steam generator) may be applicable to the present invention.

In reference to FIG. 4, another embodiment of a laundry dryer according to the present invention will be explained. This embodiment presents that the water supply source may be detachable. The water supply source might be a water tap like in the above embodiment and its installation structure may be complex in this case, because additional installation of various devices is necessary. To solve the problem, water is supplied by using a detachable water supply source 300 in this embodiment and the detachable water supply source 300 filled with water is connected to a water supply path, that is, a water supply hose 220, which is quite convenient.

In addition, a pump 400 may be provided between the water supply source 300 and the steam generator 200. It is preferable that the pump 400 is rotatable in a clockwise and counter-clockwise direction and that the pump 400 allows water to be supplied to or drained from the steam generator 200. It is possible to supply water to the steam generator 200 by using water level difference between the water supply source 300 and the steam generator 200. However, this case results in lack of structural space, because it is common that various parts of dryers are standardized goods compactly designed. As a result, the water supply using the water level difference is substantially impossible unless the sizes of conventional dryer parts are changed. While, if a small sized pump 400 is used, there may be enough space for the steam generator 200 without changing the sizes of the parts and this is very advantageous to use the pump 400 according to the present invention. If the steam generator 200 is not used for a relatively long time, the heater might be damaged by remaining water or polluted water might be used later. Thus, it is preferable that the remaining water in the steam generator 200 is drained.

While water is supplied or steam is discharged through the upper portion of the steam generator 200, it is preferable that water is supplied to the steam generator 200 through a lower portion of the steam generator 200 and that steam is discharged from the steam generator 200 through the upper portion of the steam generator 200 in this embodiment. In this case, it is convenient to drain the remaining water in the steam generator 200. In addition, it is preferable that a safety valve 500 is provided at a steam path through which steam is discharged from the steam generator 200 and the steam path is a steam hose 230.

Each configuration will be explained in detail.

First of all, in reference to FIG. 5, the detachable water supply source 300 (hereinafter, a cartridge) will be explained.

The cartridge 300 includes a lower housing 310 that substantially holds water and an upper housing 320 detachable from the lower housing 310. As a result, it is easy to wash and clean slime inside the cartridge 300. Also, it is easy to separate, clean and regenerate filters 330 and 340 and a water softening member 350.

It is preferable that a first filter 330 is provided at the upper housing 320. That is, the first filter 330 is installed at a water inlet of the upper housing 320 and water is primarily filtered when supplied to the cartridge 300.

A closable member 360 is provided at the lower housing 310 to selectively supply the water of the cartridge 300 outside. If the cartridge 300 is separated, the water of the cartridge 300 is not discharged outside and if the cartridge 300 is installed, the water is discharged outside. A second filter 360 for filtering the water may be connected to the closable member 360 and it is preferable that the second filter 360 is detachable. As a result, impurities mixed with water such as minute dirt may be filtered doubly. The first filter 330 may be formed of an approximately 50 mesh net and the second filter 340 may be formed of an approximately 60 mesh net. Here, the 50 mesh net means that the mesh number per a predetermined section is 50. As a result, a size of each mesh hole forming the first filter 330 is larger than a size of each mesh hole forming the second filter 340, such that relatively large impurities are filtered by the first filter 330 primarily and relatively small foreign impurities are filtered by the second filter secondarily.

It is preferable that a water softening member 350 is provided in the cartridge 300 to soften water. It is also preferable that the water softening member 350 is detachable.

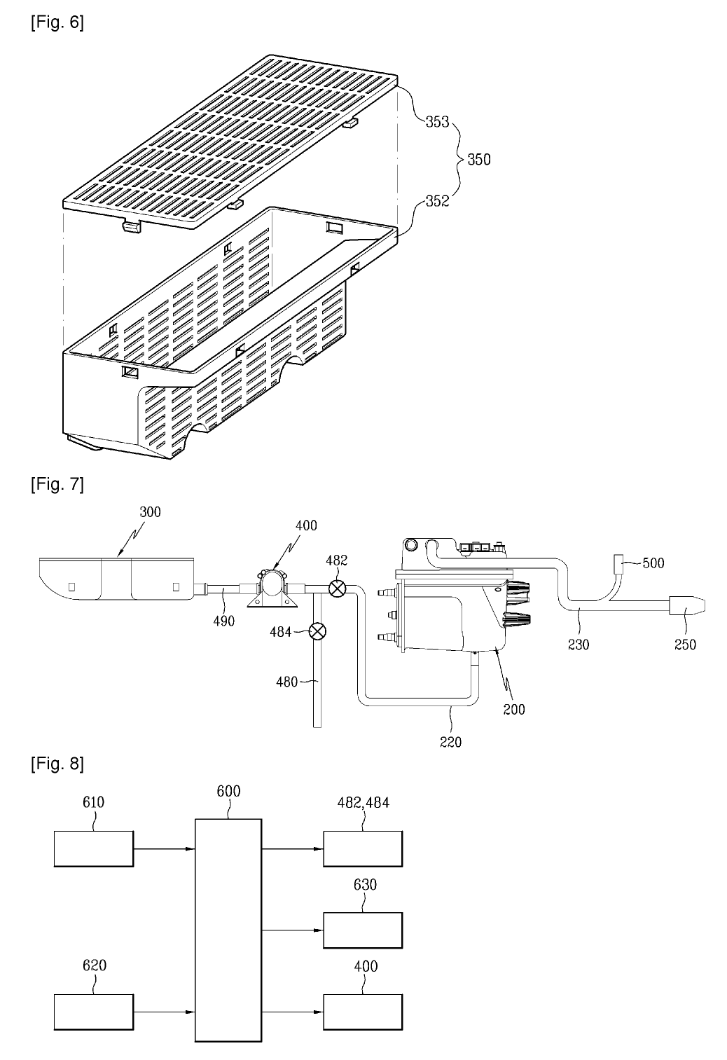

As shown in FIG. 6, the water softening member 350 includes a lower housing 352 having a plurality of holes and an upper housing 353 having a plurality of holes, being detachable from the lower housing 352. In addition, the water softening member 350 may further include an ion exchange resin (not shown) filled in a predetermined space defined by the upper housing 353 and lower housing 352.

The reason why the water softening member 350 is used will be described. If the water supplied to the steam generator 200 has a high degree of hardness, Ca (HCO₃)₂ dissolved in the water is heated and CaCO₃ is educed. Thus corrosion of the heater might be caused by lime. Especially, this corrosion might be severe in Europe and America continents, because water in those areas is soft water having a high degree of hardness. Thus, it is preferable in those areas that calcium, magnesium and the like are removed by the ion exchange resin to prevent eduction of lime. The efficiency of the ion exchange resin deteriorates as a water softening process being performed and thus the ion exchange resin is regenerated in a predetermined time period to reuse the ion exchange resin. Here, the ion exchange resin may be regenerated by using an ion exchange resin regenerator. Calcium decomposer, for example, sodium chloride (NaCl) may be used as the ion exchange resin generator. Next, NaCl will exampled as calcium decomposer on convenience sake. A water softening process by using the ion exchange is 2(R—SONa)+Ca2<−>(R—SO)Ca+2N and a ion exchange resin regenerating process by using NaCl as Calcium decomposer is (R—So)Ca+SNaCl<−>2(R—SONa)+CaCl.

On the other hand, once salt (sodium chloride-NaCl) is supplied to the cartridge 300 having the water softening member 350 and the softening member 350 is regenerated, the remaining sodium chloride dissolved in the water should be drained outside. In reference to FIG. 7, a structure for this drainage will be explained.

A drain hose 480 is connected between the pump 400 and the steam generator 200 to drain the remaining salty water outside the cartridge 300. A first valve 482 is provided between the pump 400 and the steam generator 200, especially, at an end of the drain hose 480 toward the steam generator 200 to selectively close a path of the drain hose 480, especially, a path between the pump 400 and the steam generator 200. A second valve 484 is provided at a predetermined portion of the drain hose 480 to selectively close a path of the drain hose 480. It is preferable that the first and second valve 482 and 484 is configured of a solenoid valve for control convenience.

To inform a user of a time for regenerating the water softening member, a lime sensor, a regeneration warning part and a regeneration operation instructing part may be further provided. If more than a predetermined amount of lime is sensed by the lime sensor, the regeneration warning part warns a user that the lime is sensed.

This control configuration may be embodied variously and an embodiment thereof will be explained in reference to FIG. 8.

The lime sensor 610 and the regeneration operation command part 620 are connected to an input terminal of a controller 600. Here, the regeneration operation instructing part 620 instructs a regeneration operation of the ion exchange resin. The valves 482 and 484, the regeneration warning part 630 and the pump 400 are connected to an output terminal of the controller 600. That is, once the lime sensor 610 senses more than the predetermined amount of lime, the controller 600 warns a user that the ion exchange resin should be regenerated by using the regeneration warning part 630, for example, raising an alarm or turning on/off a warning lamp. Hence, if a user selects the regeneration operation instructing part 620, the controller 600 controls the valves 482 and 484 appropriately.

In reference to FIGS. 7 and 8, an operation of the above embodiment will be described.

A path of the steam generator 200 is opened and a path of the drain hose 480 is closed during a common operation of the dryer. As a result, the water of the cartridge 300 is supplied to the steam generator 200.

If more than the predetermined amount of lime is sensed by the lime sensor 620, the controller 600 operates the regeneration warning part 630 to warn a user by using an alarm that lime is sensed. At this time, the user introduces a regenerator, for example, salt (Sodium chloride-NaCl) into the cartridge 300 and the ion exchange resin is regenerated. When regenerating the ion exchange resin, the water of the cartridge 300 should not be drained into the drum or outside. Once completing the regeneration of the ion exchange resin, it is preferable that the water dissolved with the salt is drained outside the cartridge 300. This drain prevention and drain may be performed by controlling the valves 482 and 484. A method of controlling the valves 482 and 484 may be varied and a preferred embodiment will be described. A normal-on-type valve that is usually opened is used for the first valve 482 and a normal-off-type valve that is usually closed is used for the second valve 484. This is because the water supply to the steam generator 200 should be performed during the operation of the dryer and the water drainage to an outside should be performed intermittently. In case of the above type of valve usage, a user pushes the regeneration operation instructing part 620 when the regeneration of the ion exchange resin starts. Hence, the controller 600 receiving the regeneration instruction operates the second valve 484 to be opened and operates the pump 400 to drain the water outside the cartridge 300.

On the other hand, if the types of valves 482 and 484 are changed, the valves 482 and 484 are controlled accordingly. For example, if both of the valves 482 and 484 are normal on types, the first valve 482 is opened and the second valve 484 is closed during the common operation of the dryer, and the first valve 482 is closed and the second valve 484 is opened during the ion exchange resin regeneration mode. That is, the path to the steam generator 200 is closed and the path to the drain hose 480 is opened to drain the salt water outside the cartridge 300 through the drain hose 480.

If the drain hose 480 is used in this embodiment, the water of the cartridge 300 as well as the salt water remaining after the regeneration of the water softening member may be drained outside. That is, in case that the dryer has not been used for a relatively long time, the water of the cartridge 300 may be drained outside through the drain hose 480 without separating the cartridge 300.

Alternatively, unlike the above embodiment, the salt water of the cartridge 300 may be drained without using the pump 400. For example, the drain hose 480 for draining the salt water remaining after the regeneration of the water softening member may be directly connected to the cartridge 300 and the remaining salt water may be directly drained outside by using the drain hose 480. If then, the drain hose 480 may be positioned at the cartridge 300 or between the cartridge 300 and the pump 400. Here, it is preferable that a valve is provided at the drain hose 480 to selectively open and close a path.

According to experiments performed by the inventor, although there is difference according to kinds of fabrics and humidity of the laundry, there is an effect of removing and preventing wrinkles in the present invention. For example, wrinkles of the laundry washed in a washer may be removed and the present invention is applicable to various kinds of laundry. For example, clothes worn for about a day, that is, dried laundry with fewer wrinkles may be used in the present invention. In other words, the laundry dryer according to the present invention may be used as a kind of wrinkle removal apparatus.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The present invention has an industrial applicability.

First, the laundry dryer according to the present invention has an effect of efficiently preventing wrinkles of the dried laundry in advance. In addition, the laundry may be sterilized and bad smell of the laundry may be removed.

Furthermore, the laundry dryer according to the present invention has another advantageous effect of efficiently removing wrinkles of the dried laundry without auxiliary ironing.

A still further, the laundry dryer according to the present invention has a further advantageous effect of a simple structure, because an external water tap is not connected to the steam generator provided in the laundry dryer.

1. A laundry dryer comprising:
a drum to hole laundry;
a steam generator to selectively supply steam to the drum;
a water supply source to hold water that is supplied to the steam generator;
a water softening member provided in the water supply source to soften water; and
a drain hose through which the water of the water supply source is selectively drained outside.

2. The laundry dryer as claimed in claim 1, wherein the water softening member comprises an ion exchange resin.

3. The laundry dryer as claimed in claim 2, wherein the water softening member comprises,
a lower housing provided in the water supply source, the lower housing having a plurality of through-holes;
an upper housing detachable from the lower housing, the upper housing having a plurality of through-holes,
wherein the ion exchange resin is filled up in a predetermined space formed by the upper and lower housing.

4. The laundry dryer as claimed in claim 2, further comprising:
a lime sensor to sense an amount of lime dissolved in the water of the water supply source;
a regeneration warning part to warn a user more than a predetermined amount of lime, if more than a predetermined amount of lime is sensed by the lime sensor; and
a controller to control the lime sensor and the warning part.

5. The laundry dryer as claimed in claim 4, further comprising a regeneration operation instructing part to transmit a signal to the controller, if the ion exchange resin starts to be regenerated.

6. The laundry dryer as claimed in claim 5, wherein the controller controls the water inside the water supply source to be drained through the drain hose, not to be supplied to the steam generator, if controller receives the signal from the regeneration operation instructing part.

7. The laundry dryer as claimed in claim 6, wherein the drain hose is directly connected to the water supply source.

8. The laundry dryer as claimed in claim 7, further comprising a valve to selectively open and close a path to the drain hose, wherein the controller controls the valve to be opened if the controller receives the signal from the regeneration operation instructing part.

9. The laundry dryer as claimed in claim 6, further comprising a pump to supply the water held in the water supply source to the steam generator.

10. The laundry dryer as claimed in claim 9, wherein the drain hose comprises a first valve provided between the steam generator and the pump and a second valve provided at the drain hose.

11. The laundry dryer as claimed in claim 10, wherein the controller controls to close the first valve and to open the second valve if the controller receives the signal from the regeneration operation instructing part.

12. A control method of a laundry dryer comprising a steam generator to supply steam to a drum holding laundry, a water supply source to hold water that is supplied to the steam generator and a water softening member, having an ion exchange resin, provided in the water supply source to soften the water, the method comprising:
a sensing step to sense an amount of lime dissolved in the water of the water supply source;
a warning step to warn a user more than a predetermined amount of lime, if more than predetermined amount of lime is sensed;
a regenerating step to regenerate the ion exchange resin; and
a draining step to drain the water of the water supply source outside if the ion exchange resin is regenerated.

13. The method as claimed in claim 12, wherein, in the regenerating step, a user supplies an ion exchange resin regenerator to the water supply source.

14. The method as claimed in claim 12, wherein, in the draining step, the water of the water supply source is drained outside, not supplied to the steam generator.

15. The method as claimed in claim 12, wherein, in the draining step, the water of the water supply source is drained outside by using a drain hose to selectively drain the water of the water supply source.
